(19) United States
(12) Patent Application Publication
(10) Pub. No.: US 2026/0042923 A1
(43) Pub. Date: Feb. 12, 2026

(54) PHOTOINITIATOR COMPOSITION, PHOTOCURABLE COMPOSITION, PHOTOCURABLE COMPOSITION KIT, AND PHOTOCURABLE RESIN COMPOSITIONS

(71) Applicant: OSAKA ORGANIC CHEMICAL INDUSTRY LTD., Osaka (JP)

(72) Inventor: Syunya HORII, Ishikawa (JP)

(21) Appl. No.: 19/101,302

(22) PCT Filed: Aug. 8, 2023
(86) PCT No.: PCT/JP2023/028853

§ 371 Date: Feb. 5, 2025

(30) Foreign Application Priority Data
Aug. 9, 2022 (JP) 2022-127365

(51) Int. Cl. C09D 11/30; C09D 11/101; C09D 11/107

(52) U.S. Cl. CPC C09D 11/30; C09D 11/101; C09D 11/107

(57) ABSTRACT

The purpose of the present invention is to provide: a photoinitiator composition that can suppress bleeding out to the surface of a cured product, and that can initiate radical polymerization reaction with a low irradiation dose; and a photocurable composition, a photocurable composition kit, and photocurable resin compositions that contain the photoinitiator composition. A photoinitiator composition according to the present invention contains: a hydrogen abstraction type photoinitiator having one or more functional groups including an ethylenically unsaturated double bond; and a monomer A having one or more functional groups including an ethylenically unsaturated double bond, and at least one hydrogen-donating group selected from the group consisting of a formal group, a tertiary amino group, a thioether group, and a nitrogen-containing heterocyclic rings.

### TECHNICAL FIELD

The present invention relates to a photoinitiator composition, and to a photocurable composition, a photocurable composition kit, and photocurable resin compositions each containing the photoinitiator composition.

### BACKGROUND ART

Photocurable compositions containing photoinitiators and monomer components have been widely used for, for example, coating materials, inks, adhesives, pressure-sensitive adhesives, insulating films, protective films, and films.

However, the cured product of such a conventional photocurable composition has the problem of bleedout of the photoinitiator or a decomposition product thereof.

In order to solve this problem, photoinitiators having an ethylenically unsaturated double bond and can be incorporated into polymer structures have been proposed (for example, Patent Literatures 1 and 2).

In addition, Patent Literature 3 proposes an ultraviolet crosslinking acrylic pressure-sensitive adhesive having improved photopolymerization efficiency, which is produced by crosslinking a copolymer, produced by solution polymerization of a benzophenone derivative containing an unsaturated group; an acrylic monomer containing a hydrogen-donating group; and a monomer mixture of at least one monomer to be polymerized into a polymer, by exposure to ultraviolet light.

Furthermore, Patent Literature 4 proposes a photocurable pressure-sensitive adhesive precursor composition containing an ethylenically unsaturated monomer, a prepolymer having a monomer unit derived from a hydrogen-donating monomer, and a hydrogen abstraction-type photoinitiator, for the purpose of obtaining a photocurable pressure-sensitive adhesive having sufficient heat resistance without undergoing an aging step.

### CITATION LIST

### Patent Literature

Patent Literature 1: JP S62-81345 A
Patent Literature 2: JP H2-305847 A
Patent Literature 3: JP 2006-144014 A
Patent Literature 4: JP 2017-193601 A

### SUMMARY OF INVENTION

### Technical Problem

However, in Patent Literature 3, a significant improvement in photopolymerization efficiency cannot be expected, because 2-hydroxyethyl methacrylate is used as the acrylic monomer containing a hydrogen-donating group. In Patent Literature 4, the hydrogen-donating monomer has been previously incorporated into the prepolymer structure, and thus, hydrogen abstraction is less likely to occur, and it is expected that the reactivity of radical polymerization is not significantly improved. It should be noted that Patent Literature 4 does not mention that the hydrogen abstraction-type photoinitiator is incorporated into the polymer structure.

The present invention has been made in view of the above-described problem, and an object of the present invention is to provide a photoinitiator composition that can suppress bleeding out to the surface of a cured product and initiate a radical polymerization reaction with a low irradiation dose, and also provide a photocurable composition, a photocurable composition kit, and a photocurable resin composition each containing the photoinitiator composition.

### Solution to Problem

As a result of extensive research to solve the above-described problem, the present inventor has found that the problem can be solved by the following photoinitiator composition, photocurable composition, and the like, and have accomplished the present invention.

In summary, the present invention provides the following aspects of the invention:

[1] A photoinitiator composition comprising:
a hydrogen abstraction-type photoinitiator having one or more functional groups containing an ethylenically unsaturated double bond; and
a monomer A having one or more functional groups containing an ethylenically unsaturated double bond and at least one hydrogen-donating group selected from the group consisting of a formal group, a tertiary amino group, a thioether group, and a nitrogen-containing heterocycle.

[2] The photoinitiator composition according to [1], wherein the hydrogen abstraction-type photoinitiator is at least one selected from the group consisting of a benzophenone-type photoinitiator, a xanthone-type photoinitiator, a thioxanthone-type photoinitiator, and an acridone-type photoinitiator.

[3] The photoinitiator composition according to [1] or [2], wherein the functional group containing an ethylenically unsaturated double bond of the hydrogen abstraction-type photoinitiator is a (meth)acryloyloxy group.

[4] The photoinitiator composition according to any one of [1] to [3], wherein the functional group containing an ethylenically unsaturated double bond of the monomer A is a (meth)acryloyl group or a (meth)acryloyloxy group, and the monomer A has a formal group or a tertiary amino group.

[5] The photoinitiator composition according to any one of [1] to [4], wherein the functional group containing an ethylenically unsaturated double bond of the hydrogen abstraction-type photoinitiator is an acryloyloxy group, and the functional group containing an ethylenically unsaturated double bond of the monomer A is an acryloyl group or an acryloyloxy group.

[6] A photocurable composition comprising the photoinitiator composition according to any one of [1] to [5] and a base monomer B.

[7] The photocurable composition according to [6], wherein the photocurable composition is an ultraviolet-curable inkjet ink.

[8] A photocurable composition kit comprising the photoinitiator composition according to any one of [1] to [5], and a base monomer composition containing a base monomer B.

[9] A photocurable resin composition comprising the photoinitiator composition according to any one of [1] to [5] and a resin component.

[10] A photocurable resin composition comprising the photocurable composition according to [6] and a resin component.

### Effects of Invention

The hydrogen abstraction-type photoinitiator of the present invention has one or more functional groups containing an ethylenically unsaturated double bond and thus, can be incorporated into a polymer structure, unlike general hydrogen abstraction-type photoinitiators. Therefore, the photoinitiator, a modified product thereof, and the like remaining in a cured product can be effectively prevented from bleeding out to the surface of the cured product. On the other hand, the monomer A of the present invention has at least one hydrogen-donating group selected from the group consisting of a formal group, a tertiary amino group, a thioether group, and a nitrogen-containing heterocycle, and a carbon radical generated in the hydrogen-donating group is highly stable. Therefore, hydrogen abstraction by the hydrogen abstraction-type photoinitiator is likely to occur, and a highly reactive carbon radical is likely to be generated. The photoinitiator composition of the present invention contains the hydrogen abstraction-type photoinitiator and the monomer A, and thus can effectively suppress bleeding out to the surface of a cured product and initiate a radical polymerization reaction with a low irradiation dose. In addition, the photoinitiator composition of the present invention has the above-described features, and thus is suitably used as a photoinitiator component blended in photocurable compositions (for example, ultraviolet-curable inkjet inks and coating materials), photocurable composition kits (for example, two-part adhesives and two-part pressure-sensitive adhesives), and photocurable resin compositions (for example, photosensitive resin compositions, resin compositions for hard coats, resin compositions for insulating films, pressure-sensitive adhesive compositions, and adhesive compositions). Furthermore, the photoinitiator composition of the present invention not only serves as a photoinitiator component but also as a monomer component or a crosslinking component.

### DESCRIPTION OF EMBODIMENTS

As used herein, (meth)acrylate refers to acrylate and/or methacrylate; (meth)acryloyl refers to acryloyl and/or methacryloyl; and (meth)acrylic acid refers to acrylic acid and/or methacrylic acid.

### <Photopolymerization Initiator Composition>

A photoinitiator composition of the present invention contains a hydrogen abstraction-type photoinitiator having one or more functional groups containing an ethylenically unsaturated double bond; and a monomer A (hereinafter, also referred to as “hydrogen-donating monomer A”) having one or more functional groups containing an ethylenically unsaturated double bond and at least one hydrogen-donating group selected from the group consisting of a formal group, a tertiary amino group, a thioether group, and a nitrogen-containing heterocycle.

### [Hydrogen Abstraction-Type Photoinitiator]

As used herein, the hydrogen abstraction-type photoinitiator refers to a photoinitiator that is excited by light irradiation to a high energy state, and thereby can abstract a hydrogen atom from the hydrogen-donating group of the hydrogen-donating monomer A to generate a carbon radical in the hydrogen-donating group.

The hydrogen abstraction-type photoinitiator has one or more functional groups containing an ethylenically unsaturated double bond (hereinafter, also referred to as “radically polymerizable functional groups”) in order to be incorporated into a polymer structure. The radically polymerizable functional group is not specifically limited, and examples thereof include a vinyl group, an allyl group, a styryl group, a (meth)acryloyl group, a (meth)acryloyloxy group, and a (meth)acrylamide group. From the viewpoint of improving polymerization reactivity, the radically polymerizable functional group is preferably a (meth)acryloyloxy group, and more preferably an acryloyloxy group. The hydrogen abstraction-type photoinitiator may have one type of radically polymerizable functional group, or may have two or more types of radically polymerizable functional groups. The hydrogen abstraction-type photoinitiator preferably has one to three, more preferably one or two, and even more preferably one, radically polymerizable functional group.

The hydrogen abstraction-type photoinitiator has one or more radically polymerizable functional groups, and, because a carbon radical is generated by the reaction between a ketone group excited by light irradiation and a hydrogen atom abstracted from the hydrogen-donating group of the hydrogen-donating monomer A, the hydrogen abstraction-type photoinitiator functions not only as a photoinitiator but also as a monomer component or a crosslinking component.

The hydrogen abstraction-type photoinitiator is preferably at least one selected from the group consisting of a benzophenone-type photoinitiator, a xanthone-type photoinitiator, a thioxanthone-type photoinitiator, and an acridone-type photoinitiator, and is more preferably a benzophenone-type photoinitiator. In these types of photoinitiators, the radically polymerizable functional group may be attached to any position of the ortho-, meta-, or para-position relative to a ketone group, but is preferably attached to the ortho- or para-position from the viewpoint of ease of production and the like. Alternatively, in these types of photoinitiators, the radically polymerizable functional group may be directly attached to a benzene ring, or may be attached to a benzene ring via an organic group such as an aliphatic hydrocarbon group, an alicyclic hydrocarbon group, or an aromatic hydrocarbon group, but from the viewpoint of improving polymerization reactivity, the radically polymerizable functional group is preferably directly attached to a benzene ring. In these types of photoinitiators, the benzene ring may have one or more substituents such as an alkyl group, an alkoxy group, and a halogen group.

Preferred hydrogen abstraction-type photoinitiators are photoinitiators of the structures shown below. These hydrogen abstraction-type photoinitiators may be used alone or in combinations of two or more. The photoinitiators of the following structures can each be synthesized, for example, by reacting a benzophenone having a hydroxy group, a xanthone having a hydroxy group, a thioxanthone having a hydroxy group, or an acridone having a hydroxy group, with a (meth)acrylic anhydride.

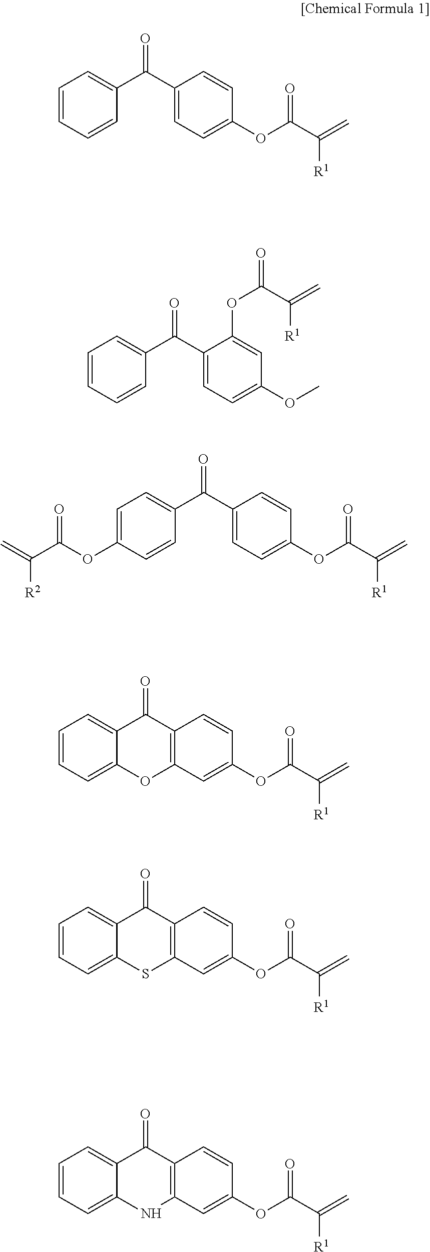

wherein R¹ and R² are each independently hydrogen or a methyl group.

### [Hydrogen-Donating Monomer A]

The hydrogen-donating monomer A has one or more radically polymerizable functional groups. The radically polymerizable functional group is not specifically limited, and examples thereof include a vinyl group, an allyl group, a styryl group, a (meth)acryloyl group, a (meth)acryloyloxy group, and a (meth)acrylamide group. From the viewpoint of initiating a radical polymerization reaction with a low irradiation dose, the radically polymerizable functional group is preferably a (meth)acryloyl group or a (meth)acryloyloxy group, and more preferably an acryloyl group or an acryloyloxy group. The hydrogen-donating monomer A may have one type of radically polymerizable functional group, or may have two or more types of radically polymerizable functional groups. The hydrogen-donating monomer A preferably has one to three, more preferably one or two, and even more preferably one, radically polymerizable functional group.

The hydrogen-donating monomer A has at least one hydrogen-donating group selected from the group consisting of a formal group, a tertiary amino group, a thioether group, and a nitrogen-containing heterocycle. These hydrogen-donating groups have a superior hydrogen-donating ability compared to a hydroxy group, a thiol group, an ether group, a primary amino group, a secondary amino group, an amide group, or an oxygen-containing heterocycle, and are more likely to generate a highly reactive carbon radical. Thus, a radical polymerization reaction can be initiated with a lower irradiation dose than that with conventional hydrogen-donating monomers. The hydrogen-donating monomer A preferably has a formal group or a tertiary amino group, from the viewpoint of having an even superior hydrogen-donating ability and being more likely to generate a carbon radical, and more preferably has a formal group from the viewpoint of having less effect on the human body and effectively preventing coloring of the cured product.

The formal group is a group having a methylene group between two oxygen atoms, and may have a cyclic structure (hereinafter, also referred to as a “cyclic formal group”) or a chain structure (hereinafter, also referred to as a “chain formal group”). Examples of the cyclic formal group include a 1,3-dioxetane ring, a 1,3-dioxolane ring, a 1,3-dioxane ring, a 1,3,5-trioxane ring, a 1,3-benzodioxole ring, and a 1,3-benzodioxane ring. Examples of the chain formal group include groups having the —R³—O—CH₂—O—R⁴ structure or the —R³—O—CH₂—O—R⁵-structure. R³ and R⁵ are each independently a single bond or an aliphatic hydrocarbon group having 1 to 10 carbon atoms, preferably a single bond or an aliphatic hydrocarbon group having 1 to 6 carbon atoms, more preferably a single bond or an aliphatic hydrocarbon group having 1 to 4 carbon atoms, and even more preferably a single bond or an aliphatic hydrocarbon group having 1 or 2 carbon atoms. R⁴ is an aliphatic hydrocarbon group having 1 to 10 carbon atoms, preferably an aliphatic hydrocarbon group having 1 to 6 carbon atoms, more preferably an aliphatic hydrocarbon group having 1 to 4 carbon atoms, and even more preferably an aliphatic hydrocarbon group having 1 or 2 carbon atoms.

The tertiary amino group is not specifically limited, and examples thereof include a tertiary amino group with an aliphatic hydrocarbon group having 1 to 10 carbon atoms, preferably a tertiary amino group with an aliphatic hydrocarbon group having 1 to 6 carbon atoms, more preferably a tertiary amino group with an aliphatic hydrocarbon group having 1 to 4 carbon atoms, and even more preferably a tertiary amino group with an aliphatic hydrocarbon group having 1 or 2 carbon atoms.

The thioether group is not specifically limited, and examples thereof include groups having the —R⁶—S—R⁷ structure or the —R⁶—S—R⁸-structure. R⁶ to R⁸ are each independently an aliphatic hydrocarbon group having 1 to 10 carbon atoms, preferably an aliphatic hydrocarbon group having 1 to 6 carbon atoms, more preferably an aliphatic hydrocarbon group having 1 to 4 carbon atoms, and even more preferably an aliphatic hydrocarbon group having 1 or 2 carbon atoms.

The nitrogen-containing heterocycle is not specifically limited as long as it is a heterocycle having one or more nitrogens, and examples thereof include an aziridine ring, an azetidine ring, a pyrrolidine ring, a pyrroline ring, a piperidine ring, an azepane ring, an imidazolidine ring, an imidazoline ring, a pyrazolidine ring, a pyrazoline ring, an oxazolidine ring, a thiazolidine ring, a piperazine ring, a morpholine ring, a thiomorpholine ring, a triazacyclohexane ring, an azaadamantane ring, and a hexamethylenetetramine ring.

The hydrogen-donating monomer A has one or more radically polymerizable functional groups, and also functions as a crosslinking component because a carbon radical is generated on the hydrogen-donating group by hydrogen abstraction.

Preferred hydrogen-donating monomers A are a trialkanolamine tri(meth)acrylate (the carbon number of each alkanol group is preferably 1 to 10, more preferably 1 to 6, even more preferably 1 to 4, and particularly preferably 1 or 2), a piperonyl (meth)acrylate, and the compounds shown below. These hydrogen-donating monomers A may be used alone or in combinations of two or more.

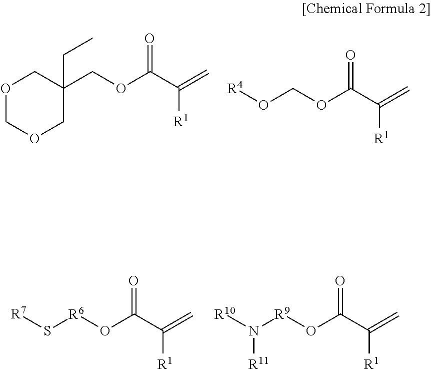

wherein R¹ is hydrogen or a methyl group, and R⁴, R⁶, R⁷, and R⁹ to R¹¹ are each independently an aliphatic hydrocarbon group having 1 to 10 carbon atoms, preferably an aliphatic hydrocarbon group having 1 to 6 carbon atoms, more preferably an aliphatic hydrocarbon group having 1 to 4 carbon atoms, and even more preferably an aliphatic hydrocarbon group having 1 or 2 carbon atoms.

The radically polymerizable functional group of the hydrogen abstraction-type photoinitiator and the radically polymerizable functional group of the hydrogen-donating monomer A are preferably the same or the same type of functional groups from the viewpoint of initiating a radical polymerization reaction with a low irradiation dose. More preferably, the radically polymerizable functional group of the hydrogen abstraction-type photoinitiator is a (meth)acryloyloxy group, and the radically polymerizable functional group of the hydrogen-donating monomer A is a (meth)acryloyl group or a (meth)acryloyloxy group. Particularly preferably, the radically polymerizable functional group of the hydrogen abstraction-type photoinitiator is an acryloyloxy group, and the radically polymerizable functional group of the hydrogen-donating monomer A is an acryloyl group or an acryloyloxy group.

In the photoinitiator composition of the present invention, a molar ratio of the hydrogen abstraction-type photoinitiator to the hydrogen-donating monomer A (hydrogen abstraction-type photoinitiator: hydrogen-donating monomer A) is preferably 1:5 to 5:1, more preferably 1:4 to 4:1, and even more preferably 1:3 to 3:1, from the viewpoint of initiating a radical polymerization reaction with a low irradiation dose. In one embodiment of the photoinitiator composition of the present invention, the molar ratio (hydrogen abstraction-type photoinitiator: hydrogen-donating monomer A) is preferably 1:2 to 1:5, and more preferably 1:3 to 1:4.

The photoinitiator composition of the present invention may optionally contain photoinitiators other than the hydrogen abstraction-type photoinitiator, photoinitiator aids, solvents, and the like.

In the photoinitiator composition of the present invention, a total content of the hydrogen abstraction-type photoinitiator and the hydrogen-donating monomer A is usually 1 to 100% by mass, preferably 10 to 80% by mass, and more preferably 20 to 50% by mass.

The photoinitiator composition of the present invention can suppress bleeding out to the surface of a cured product and coloring of the cured product, and can initiate a radical polymerization reaction with a low irradiation dose, and thus is suitably used as a photoinitiator component blended in photocurable compositions (for example, ultraviolet-curable inkjet inks and coating materials), photocurable composition kits (for example, two-part adhesives and two-part pressure-sensitive adhesives), and photocurable resin compositions (for example, photosensitive resin compositions, resin compositions for hard coats, resin compositions for insulating films, pressure-sensitive adhesive compositions, and adhesive compositions). Furthermore, the photoinitiator composition of the present invention not only serves as a photoinitiator component but also as a monomer component or a crosslinking component.

### <Photocurable Composition>

A photocurable composition of the present invention contains the photoinitiator composition and a base monomer B.

The base monomer B is a main monomer for forming a polymer, and examples thereof include a monofunctional monomer and a polyfunctional monomer.

Examples of the monofunctional monomer include alkyl (meth)acrylates, such as methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, sec-butyl (meth)acrylate, n-pentyl (meth)acrylate, n-hexyl (meth)acrylate, n-octyl (meth)acrylate, isooctyl (meth)acrylate, n-nonyl (meth)acrylate, isononyl (meth)acrylate, 2-ethylhexyl (meth)acrylate, decyl (meth)acrylate, dodecyl (meth)acrylate, tridecyl (meth)acrylate, tetradecyl (meth)acrylate, hexadecyl (meth)acrylate, octadecyl (meth)acrylate, isostearyl (meth)acrylate, eicosyl (meth)acrylate, and behenyl (meth)acrylate: alicyclic group-containing (meth)acrylates, such as cyclohexyl (meth)acrylate, t-butylcyclohexyl (meth)acrylate, isobornyl (meth)acrylate, dicyclopentanyl (meth)acrylate, dicyclopentenyl (meth)acrylate, and adamantyl (meth)acrylate: heterocycle-containing (meth)acrylates, such as glycidyl (meth)acrylate and tetrahydrofurfuryl (meth)acrylate; alkoxy group-containing (meth)acrylates, such as 2-methoxyethyl (meth)acrylate, 2-ethoxyethyl (meth)acrylate, ethyl carbitol (meth)acrylate, and nonylphenyl carbitol (meth)acrylate: hydroxy group-containing (meth)acrylates, such as hydroxyethyl (meth)acrylate and hydroxypropyl (meth)acrylate: aryl group-containing (meth)acrylates, such as benzyl (meth)acrylate and phenoxyethyl (meth)acrylate; carboxy group-containing monomers, such as (meth)acrylic acid, 2-(meth)acryloyloxyethyl succininate, maleic acid, and itaconic acid: carboxylic acid anhydride group-containing monomers, such as maleic anhydride and itaconic anhydride: styrene and styrene derivatives such as methylstyrene; maleimide derivatives, such as cyclohexylmaleimide, phenylmaleimide, methylmaleimide, ethylmaleimide, n-butylmaleimide, and laurylmaleimide; and N-vinylpyrrolidone, vinyl acetate, and vinyl acetate alcohol. These monofunctional monomers may be used alone or in combinations of two or more.

Examples of the polyfunctional monomer include polyfunctional aromatic vinyl-based monomers, such as divinylbenzene, diallyl phthalate, and diallyl benzenephosphonate; and polyfunctional (meth)acrylates, such as (di)ethylene glycol di(meth)acrylate, propylene glycol di(meth)acrylate, trimethylolpropane di(meth)acrylate, trimethylolpropane tri(meth)acrylate, pentaerythritol di(meth)acrylate, pentaerythritol tri(meth)acrylate, pentaerythritol tetra(meth)acrylate, dipentaerythritol di(meth)acrylate, dipentaerythritol tri(meth)acrylate, dipentaerythritol tetra(meth)acrylate, dipentaerythritol penta (meth)acrylate, dipentaerythritol hexa (meth)acrylate, and tris(hydroxyethyl) isocyanurate tri(meth)acrylate. These polyfunctional monomers may be used alone or in combinations of two or more.

In the photocurable composition of the present invention, the content of the base monomer B is usually about 5 to 95% by mass, preferably 10 to 90% by mass, and more preferably 50 to 80% by mass.

In the photocurable composition of the present invention, the content of the photoinitiator composition is usually about 5 to 95% by mass, and is preferably 10 to 90% by mass, and more preferably 20 to 50% by mass from the viewpoint of imparting sufficient reactivity and from the viewpoint of achieving the function derived from the base monomer B.

In the photocurable composition of the present invention, from the viewpoint of imparting sufficient reactivity and from the viewpoint of achieving the function derived from the base monomer B, the content of the base monomer B relative to the total content of the hydrogen abstraction-type photoinitiator and the hydrogen-donating monomer A in the photoinitiator composition, i.e., the content of the base monomer B: the total content of the hydrogen abstraction-type photoinitiator and the hydrogen-donating monomer A in the photoinitiator composition, is preferably 40 to 95:60 to 5, more preferably 50 to 90:50 to 10, and even more preferably 55 to 85:45 to 15 in terms of molar ratio.

The photocurable composition of the present invention may optionally contain photoinitiators other than the hydrogen abstraction-type photoinitiator, radical polymerizable oligomers such as an unsaturated polyester, an epoxy acrylate, a urethane acrylate, and a polyester acrylate, photoinitiator aids, solvents, and the like.

When the photocurable composition of the present invention is an ultraviolet-curable inkjet ink or coating material, the photocurable composition may optionally contain known components such as sensitizers, sensitization aids, coloring materials (pigments and dyes), dispersion agents, slip agents (surfactants), wetting agents (humectants), surface conditioners, antioxidants, ultraviolet absorbers, chelating agents, pH adjusters, and stabilizers.

### <Photocurable Composition Kit>

A photocurable composition kit of the present invention contains at least the photoinitiator composition, and a base monomer composition containing a base monomer B.

The base monomer B is a main monomer for forming a polymer, and examples thereof include the above-described monofunctional monomer and polyfunctional monomer. These monomers may be used alone or in combinations of two or more. In the base monomer composition, the content of the base monomer B is usually about 5 to 95% by mass, preferably 10 to 90% by mass, and more preferably 50 to 80% by mass.

The base monomer composition may optionally contain photoinitiators other than the hydrogen abstraction-type photoinitiator, radical polymerizable oligomers such as an unsaturated polyester, an epoxy acrylate, a urethane acrylate, and a polyester acrylate, photoinitiator aids, solvents, and the like.

Examples of the photocurable composition kit of the present invention include a two-part adhesive and a two-part pressure-sensitive adhesive.

### <Photocurable Resin Composition>

A photocurable resin composition of the present invention contains the photoinitiator composition or the photocurable composition, and a resin component. That is, representative examples of the photocurable resin composition include (1) an embodiment containing the photoinitiator composition and a resin component; and (2) an embodiment containing the photoinitiator composition, the base monomer B, and a resin component.

The resin component needs to be appropriately selected according to the use of the photocurable resin composition. For example, for use as a photosensitive resin composition, a known alkali-soluble resin can be used as the resin component: for use as a resin composition for a hard coat or a resin composition for an insulating film, a known curable resin can be used as the resin component; and for use as a pressure-sensitive adhesive composition and an adhesive composition, a known base polymer can be used as the resin component.

In the photocurable resin composition of the present invention, the content of the resin component needs to be appropriately adjusted according to the use of the photocurable resin composition, but is usually about 5 to 95% by mass, preferably 10 to 90% by mass, and more preferably 50 to 80% by mass.

In the photocurable resin composition of the present invention, the content of the photoinitiator composition needs to be appropriately adjusted according to the use of the photocurable resin composition, but is usually about 5 to 95% by mass, preferably 10 to 90% by mass, and more preferably 20 to 50% by mass.

In the photocurable resin composition of the present invention, the content of the photocurable composition needs to be appropriately adjusted according to the use of the photocurable resin composition, but is usually about 5 to 95% by mass, preferably 10 to 90% by mass, and more preferably 20 to 50% by mass.

The photocurable resin composition of the present invention may optionally contain radical polymerizable oligomers such as an unsaturated polyester, an epoxy acrylate, a urethane acrylate, and a polyester acrylate, photoinitiator aids, solvents, and the like.

The photocurable resin composition of the present invention may optionally contain known additives, for example, fillers such as aluminum hydroxide, talc, clay, and barium sulfate, crosslinking agents, dyes, pigments, antifoaming agents, coupling agents, leveling agents, sensitizers, mold release agents, lubricants, plasticizers, stabilizers, antioxidants, ultraviolet absorbers, flame retardants, polymerization inhibitors, thickeners, tackifiers, and dispersion agents.

Examples of the photocurable resin composition of the present invention include a photosensitive resin composition, a resin composition for a hard coat, a resin composition for an insulating film, a pressure-sensitive adhesive composition, and an adhesive composition.

### <Cured Product>

Examples of the cured product obtained by curing the photocurable composition, the photocurable composition kit, or the photocurable resin composition of the present invention include a lens (microlens), a photospacer, a partition material, an insulating film, a protective film, a hard coat layer, a film, an optical waveguide material, a planarization film material, a pressure-sensitive adhesive layer, and an adhesive layer.

### EXAMPLES

The present invention will be hereinafter described with reference to examples; however, the present invention is in no way limited to these examples.

### Example 1

A 30 mL glass vessel was charged with 80 parts by mole of isobornyl acrylate (IBXA) as a base monomer B, 10 parts by mole of 4-acryloyloxybenzophenone (BPHA) as a hydrogen abstraction-type photoinitiator, and 10 parts by mole of triethanolamine triacrylate (EtAA3N) as a hydrogen-donating monomer A, and the mixture was stirred for 10 minutes to prepare a photocurable composition.

### Examples 2 to 14 and Comparative Example 1 to 14

Photocurable compositions were prepared as in Example 1, except that the compounds and the proportions (part(s) by mole) were changed as shown in Table 1. The compounds shown in Tables 1 and 2 are as follows:
Base monomer B
   IBXA: Isobornyl acrylate
   BZA: Benzyl acrylate
   NOAA: n-Octyl acrylate
Hydrogen abstraction-type photoinitiator
   BPHA: 4-Acryloyloxybenzophenone
   MeOBPHA: 2-Acryloyloxy-4-methoxybenzophenone
Hydrogen-donating monomer A
   EtAA3N: Triethanolamine triacrylate
   DMA: 2-(Dimethylamino)ethyl acrylate
   DMMA: 2-(Dimethylamino)ethyl methacrylate
   DEMA: 2-(Diethylamino)ethyl methacrylate
   V #200: Cyclic trimethylolpropane formal acrylate
   MOMA: Methoxymethyl acrylate
   CTFMA: Cyclic trimethylolpropane formal methacrylate
   PIPEMA: Piperonyl methacrylate
Hydrogen-donating monomer X
   2MTA: Methoxyethyl acrylate
   HEA: 2-Hydroxyethyl acrylate
   AIB: Isobutyl acrylate
   HEMA: 2-Hydroxyethyl methacrylate
Hydrogen-donating compound Y
   CTFOH: Cyclic trimethylolpropane formal

### [Evaluations and Measurements]

### (Minimum Curing Irradiation Dose)

Each of the photocurable compositions prepared was used in an amount of 0.03 g, and the modulus of elasticity of each composition was measured using a rheometer while irradiating the composition with light using a mercury-xenon lamp with an illumination intensity of 20 mW/cm², and the point at which the modulus of elasticity started to increase was taken as the minimum cure irradiation dose (mJ/cm²). The results are shown in Tables 1 and 2.

### (Evaluation of Yellowing)

Each of the photocurable compositions prepared was used in an amount of 0.03 g, and each photocurable composition was photocured with the above-described mercury-xenon lamp at an irradiation dose of 15.6 J/cm² to produce a cured film. The cured film thus produced was visually checked for yellowing. The results are shown in Tables 1 and 2.

(Evaluation of Bleeding out)

A photocurable composition was prepared by mixing 5 parts by mole of pentaerythritol triacrylate (PETA) as a base monomer B, 75 parts by mole of cyclic trimethylolpropane formal acrylate (V #200) as a hydrogen-donating monomer A, and 20 parts by mole of 4-acryloyloxybenzophenone (BPHA) as a hydrogen abstraction-type photoinitiator. The photocurable composition prepared was applied onto an aluminum plate to form a film having a thickness of 20 μm using a bar coater. The film was then irradiated with light at 3 J/cm² using a high-pressure mercury lamp to produce a cured film. The cured film was scraped off, and immersed in acetonitrile: water=90:10 (vol/vol) for 30 minutes. The supernatant after immersion was subjected to liquid chromatography measurement to determine the amount of eluted BPHA. As a result, the amount of eluted BPHA was 1.8% by mass of the amount added.

A cured film was prepared in the same manner as described above, except that 20 parts by mole of 2,4,6-trimethylbenzoyldiphenylphosphine oxide (TPO) was used as a photoinitiator instead of 20 parts by mole of 4-acryloyloxybenzophenone (BPHA) used as a hydrogen abstraction-type photoinitiator. The cured film was scraped off, and immersed in acetonitrile: water=90:10 (vol/vol) for 30 minutes. The supernatant after immersion was subjected to liquid chromatography measurement to determine the amount of eluted TPO. As a result, the amount of eluted TPO was 14.8% by mass of the amount added.

These results showed that the photoinitiator composition and the photocurable composition of the present invention can effectively suppress bleeding out of the photoinitiator to the surface of the cured film.

TABLE 1

| | | | Ex. 1 | Ex. 2 | Ex. 3 | Ex. 4 | Ex. 5 | Ex. 6 | Ex. 7 | Ex. 8 |
|---|---|---|---|---|---|---|---|---|---|---|
| Composition | Base monomer B | IBXA | 80 | 80 | 80 | 80 | 80 | 80 | 80 | |
| (part(s) by | | BZA | | | | | | | | 80 |
| mole) | | NOAA | | | | | | | | |
| | Hydrogen abstraction- | BPHA | 10 | 10 | 10 | 10 | 10 | 10 | 10 | 10 |
| | type photoinitiator | MeOBPHA | | | | | | | | |
| | Hydrogen-donating | EtAA3N | 10 | | | | | | | |
| | monomer A | DMA | | 10 | | | | | | |
| | | DMMA | | | | | | 10 | | |
| | | DEMA | | | | | 10 | | | |
| | | V#200 | | | 10 | | | | | 10 |
| | | MOMA | | | | 10 | | | | |
| | | CTFMA | | | | | | | 10 | |
| | | PIPEMA | | | | | | | | |
| | Hydrogen-donating | 2MTA | | | | | | | | |
| | monomer X | HEA | | | | | | | | |
| | | AIB | | | | | | | | |
| | | HEMA | | | | | | | | |
| | Hydrogen-donating | CTFOH | | | | | | | | |
| | compound Y | Ethylene glycol | | | | | | | | |
| | | Triethylamine | | | | | | | | |
| Properties | Minimum curing | mJ/cm² | 81 | 81 | 398 | 350 | 326 | 398 | 1382 | 398 |
| | irradiation dose | | | | | | | | | |
| | Yellowing of Film | Visually Checked | Yes | Yes | No | No | Yes | Yes | No | No |

| | | | Ex. 9 | Ex. 10 | Ex. 11 | Ex. 12 | Ex. 13 | Ex. 14 |
|---|---|---|---|---|---|---|---|---|
| Composition | Base monomer B | IBXA | | 60 | 60 | 60 | 80 | 80 |
| (part(s) by | | BZA | | | | | | |
| mole) | | NOAA | 80 | | | | | |
| | Hydrogen abstraction- | BPHA | 10 | 20 | 30 | 10 | | 10 |
| | type photoinitiator | MeOBPHA | | | | | 10 | |
| | Hydrogen-donating | EtAA3N | | | | | | |
| | monomer A | DMA | | | | | | |
| | | DMMA | | | | | | |
| | | DEMA | | | | | | |
| | | V#200 | 10 | 20 | 10 | 30 | 10 | |
| | | MOMA | | | | | | |
| | | CTFMA | | | | | | |
| | | PIPEMA | | | | | | 10 |
| | Hydrogen-donating | 2MTA | | | | | | |
| | monomer X | HEA | | | | | | |
| | | AIB | | | | | | |
| | | HEMA | | | | | | |
| | Hydrogen-donating | CTFOH | | | | | | |
| | compound Y | Ethylene glycol | | | | | | |
| | | Triethylamine | | | | | | |
| Properties | Minimum curing | mJ/cm² | 550 | 350 | 473 | 326 | 1012 | 398 |
| | irradiation dose | | | | | | | |
| | Yellowing of Film | Visually Checked | No | No | No | No | No | No |

TABLE 2

| | | | Comp. | Comp. | Comp. | Comp. | Comp. | Comp. | Comp. |
|---|---|---|---|---|---|---|---|---|---|
| | | | Ex. 1 | Ex. 2 | Ex. 3 | Ex. 4 | Ex. 5 | Ex. 6 | Ex. 7 |
| Composition | Base monomer B | IBXA | 80 | 90 | 80 | 80 | 80 | | 60 |
| (part(s) by | | BZA | | | | | | 80 | |
| mole) | | NOAA | | | | | | | |
| | Hydrogen abstraction- | BPHA | 10 | 10 | 10 | 10 | 10 | 10 | 20 |
| | type photoinitiator | MeOBPHA | | | | | | | |
| | Hydrogen-donating | EtAA3N | | | | | | | |
| | monomer A | DMA | | | | | | | |
| | | DMMA | | | | | | | |
| | | DEMA | | | | | | | |
| | | V#200 | | | | | | | |
| | | MOMA | | | | | | | |
| | | CTFMA | | | | | | | |
| | Hydrogen-donating | 2MTA | | | | 10 | | | |
| | monomer X | HEA | 10 | | | | | 10 | 20 |
| | | AIB | | | 10 | | | | |
| | | HEMA | | | | | 10 | | |
| | Hydrogen-donating | CTFOH | | | | | | | |
| | compound Y | Ethylene glycol | | | | | | | |
| | | Triethylamine | | | | | | | |
| Properties | Minimum curing | mJ/cm² | 550 | 713 | 828 | 603 | 3322 | 630 | 473 |
| | irradiation dose | | | | | | | | |
| | Yellowing of Film | Visually Checked | No | No | No | No | No | No | No |
| | | | Comp. | Comp. | Comp. | Comp. | Comp. | Comp. | Comp. |
| | | | Ex. 8 | Ex. 9 | Ex. 10 | Ex. 11 | Ex. 12 | Ex. 13 | Ex. 14 |
| Composition | Base monomer B | IBXA | 60 | 60 | 80 | 80 | 80 | | 80 |
| (part(s) by | | BZA | | | | | | | |
| mole) | | NOAA | | | | | | 80 | |
| | Hydrogen abstraction- | BPHA | 30 | 10 | 10 | 10 | 10 | 10 | |
| | type photoinitiator | MeOBPHA | | | | | | | 10 |
| | Hydrogen-donating | EtAA3N | | | | | | | |
| | monomer A | DMA | | | | | | | |
| | | DMMA | | | | | | | |
| | | DEMA | | | | | | | |
| | | V#200 | | | | | | | |
| | | MOMA | | | | | | | |
| | | CTFMA | | | | | | | |
| | Hydrogen-donating | 2MTA | | | | | | | |
| | monomer X | HEA | 10 | 30 | | | | 10 | 10 |
| | | AIB | | | | | | | |
| | | HEMA | | | | | | | |
| | Hydrogen-donating | CTFOH | | | 10 | | | | |
| | compound Y | Ethylene glycol | | | | 10 | | | |
| | | Triethylamine | | | | | 10 | | |
| Properties | Minimum curing | mJ/cm² | 498 | 550 | 448 | 603 | 145 | 713 | 1242 |
| | irradiation dose | | | | | | | | |
| | Yellowing of Film | Visually Checked | No | No | No | No | Yes | No | No |

As can be seen from Tables 1 and 2, the photocurable compositions of Examples 1 to 14 can initiate radical polymerization reactions with lower irradiation doses than those for the photocurable compositions of Comparative Examples 1 to 14. In addition, it can be seen that yellowing of the cured film can be effectively suppressed by using the hydrogen-donating monomer A having a formal group.

### INDUSTRIAL APPLICABILITY

The photoinitiator composition of the present invention is useful as a photoinitiator component blended in photocurable compositions (for example, ultraviolet-curable inkjet inks and coating materials), photocurable composition kits (for example, two-part adhesives and two-part pressure-sensitive adhesives), and photocurable resin compositions (for example, photosensitive resin compositions, resin compositions for hard coats, resin compositions for insulating films, pressure-sensitive adhesive compositions, and adhesive compositions).

1. A photoinitiator composition comprising:
a hydrogen abstraction-type photoinitiator having one or more functional groups containing an ethylenically unsaturated double bond; and
a monomer A having one or more functional groups containing an ethylenically unsaturated double bond and at least one hydrogen-donating group selected from the group consisting of a formal group, a tertiary amino group, a thioether group, and a nitrogen-containing heterocycle.

2. The photoinitiator composition according to claim 1, wherein the hydrogen abstraction-type photoinitiator is at least one selected from the group consisting of a benzophenone-type photoinitiator, a xanthone-type photoinitiator, a thioxanthone-type photoinitiator, and an acridone-type photoinitiator.

3. The photoinitiator composition according to claim 1, wherein the functional group containing an ethylenically unsaturated double bond of the hydrogen abstraction-type photoinitiator is a (meth)acryloyloxy group.

4. The photoinitiator composition according to claim 1, wherein the functional group containing an ethylenically unsaturated double bond of the monomer A is a (meth)acryloyl group or a (meth)acryloyloxy group, and the monomer A has a formal group or a tertiary amino group.

5. The photoinitiator composition according to claim 1, wherein the functional group containing an ethylenically unsaturated double bond of the hydrogen abstraction-type photoinitiator is an acryloyloxy group, and the functional group containing an ethylenically unsaturated double bond of the monomer A is an acryloyl group or an acryloyloxy group.

6. A photocurable composition comprising the photoinitiator composition according to claim 1 and a base monomer B.

7. The photocurable composition according to claim 6, wherein the photocurable composition is an ultraviolet-curable inkjet ink.

8. A photocurable composition kit comprising the photoinitiator composition according to claim 1, and a base monomer composition containing a base monomer B.

9. A photocurable resin composition comprising the photoinitiator composition according to claim 1 and a resin component.

10. A photocurable resin composition comprising the photocurable composition according to claim 6 and a resin component.
